(19) United States
(12) Patent Application Publication
(10) Pub. No.: US 2004/0262158 A1
(43) Pub. Date: Dec. 30, 2004

(54) Solid-state beta detector for microfluidic devices

(75) Inventors: Charles W. Alvord, Farragut, TN (US); Charles Russell Buchanan, Knoxville, TN (US); Joseph C. Matteo, Walland, TN (US); Henry Clifton Padgett, Hermosa Beach, CA (US); Thomas Lee Collier, Paramus, NJ (US)

Correspondence Address: PITTS AND BRITTIAN P C, P O BOX 51295, KNOXVILLE, TN, 37950-1295, US

(73) Assignee: Molecular Technologies, Inc., Culver City, CA

(21) Appl. No.: 10/828,844

(22) Filed: Apr. 21, 2004

Related U.S. Application Data
(60) Provisional application No. 60/464,424, filed on Apr. 22, 2003.

(51) Int. Cl. G01N 27/26; G01N 27/27

(52) U.S. Cl. 204/400

(57) ABSTRACT

A beta detector assembly for use in the synthesis and analysis of radiopharmaceuticals, such as in microfluidic radiochromatography. The beta detector assembly includes a base, preferably fabricated from glass so as to take advantage of electroosmotic flow, that serves as the body of the beta detector assembly. A microfluidic channel passes through the length of the base. A solid-state charge particle detector, for detecting beta particles, is provided and is positioned with respect to the base so as to receive beta particles. A portion of the base is disposed between the microfluidic channel and the solid-state charge particle detector and has a thickness that is selected to substantially allow transmission of beta particles there thru for detection by the charge particle detector. In one embodiment, the base is fabricated of glass. In another embodiment, the base is fabricated of silicon such that the base and the solid-state charge particle detector are integral.

### CROSS-REFERENCE TO RELATED APPLICATIONS

This non-provisional patent application claims the benefit of U.S. Provisional Application No. 60/464,424 filed Apr. 22, 2003

### STATEMENT REGARDING FEDERALLY SPONSORED RESEARCH OR DEVELOPMENT

Not Applicable

### BACKGROUND OF THE INVENTION

1. Field of Invention

The present invention pertains to the field of synthesis and analysis of radiopharmaceuticals for research and clinical use.

More particularly, this invention is a solid state beta detector for use in microfluidic devices.

2. Description of the Related Art

In the field of Positron Emission Tomography, an important area of innovation and growth is in the rapid and flexible synthesis and analysis of radiopharmaceuticals for research and clinical use. One of the preparative and analytical techniques that are required for radiopharmaceutical production is radiochromatography.

In radiochromatography one needs to quantify concentration of positron emitters in flowing or stationary liquids. Using new chemistry techniques developed on the micron scale in recent years (e.g. “Lab-on-a-chip” or μTAS), new radioanalytical devices are possible and needed. As with other aspects of microfluidic chemistry, the scale of the devices can be exploited in new ways. The unique features of microfluidic separations also place new challenges on measurement systems such as radioactivity detectors.

In the specific case proposed here, the small channels and wall thicknesses raise the possibility of using solid-state detectors to detect positrons themselves instead of the annihilation gammas. The range of the positrons in glass, combined with the ability to microfabricate detectors, collimators and reagent channels all in one device, makes this possible. The resulting device would be attractive relative to the current state of the art in terms of disposability, and reduced manufacturing variance. The sensitivity, range and spatial resolution of the device vary depending on geometry, and have been optimized here.

Solid-state detectors can be used to detect charged particles and gamma rays. For detection of photons, solid-state detectors rely on Photoelectrons or Compton electron generation, which in turn generates ionizations. However at 511 keV, Compton and photoelectric processes are low probability. The gamma detection efficiency for typical silicon detectors at 511 keV (annihilation photons) is less than 1%.

Coupled to scintillators such as LSO, photodiodes are more efficient. Disregarding any effects due to geometry, the so-called absorption efficiency of a 4 mm thick piece of LSO for 511 keV gammas is about 40%. However, there is no natural collimation of this radiation detection method (without coincidence counting). A lead shield is required to remove contribution from outside the sensitive volume and the spatial resolution is poor. Even with a very small chip of LSO (1 mm wide, 5 mm from fluid) the geometric efficiency is about 3.2%, and overall efficiency is 1.3%.

However detection efficiency of charged particles in a solid-state detector is nearly 100%. That is because the charged particles are constantly giving up energy as they pass through matter. Electron-hole pairs are produced in silicon with approximately 3 eV of energy. Even after they pass through the glass window between the channel and the detector, the positrons will have energies of hundreds of keV, and can be completely stopped in a detector of 100 μm thickness. The sensitive areas in fully depleted silicon detectors can be on the order of millimeters. This means that each positron that hits the detector will generate on the order of 105 electron-hole pairs.

In this way, the photons are expected to contribute a very small background to the overall response of the detector. However, since the photons that reach the detector can come from a much larger part of the channel geometry, the photon contribution has been modeled. In calculations it presents no problem.

The silicon detector is expected to be operated in ratemeter mode. Energy measurement is of no interest in that the radiation to be detected will be positrons of a known branching ratio. Event rate can be correlated roughly to activity, and will be calibrated for changes in isotope or radical departures in concentration. The detector is expected to be linear over a broad range of concentrations, but the pulse rise time for various detectors have been evaluated in terms of estimating an upper activity concentration limit. Because the detector will be operated by counting betas, the lower activity limit will be primarily geometry based.

Chromatography is the branch of chemistry that exploits solubility differences of various compounds to separate and analyze them. The compound or mixture to be analyzed or separated is dissolved in a solvent (gas, liquid or supercritical fluid). This solvent is passed over a solid material that has unique solubility properties for the material to be separated. The gas or liquid is called the mobile phase. The solid is called the stationary phase. The various components in the mixture will spend varying amounts of time in solution with the stationary phase, and will reach the end of the stationary phase with varying delays from the arrival of the solvent front. These delays are called the retention time of the component. The retention time is characteristic of the material being separated, the mobile and stationary phases, as well as the flow rate of the mobile phase.

The peak width of the analyte is proportional to the retention time, and is affected by flow rate and stationary phase characteristics as well. Eddy diffusion in the mobile phase acts to broaden the concentration band. Longitudinal diffusion counteracts the concentration effect, and increases with time on the separation column.

Typical flow rates in liquid chromatography are 100 μl to a few ml per minute. The dimensions of capillary tubing used are typically 0.005″ diameter, and peak widths are typically on the order of 10 seconds to a minute. Correspondingly, flow velocities are typically a few meters per minute, and the anticipated peak length is more than a meter. For this reason it is not extraordinary to have the capillary tubing wrapped around the detector many times in a typical radioanalytical applications. However, with the advent of microfluidic separation techniques this is no longer appropriate.

Microfluidic chemistry methods roughly parallel the development of microfabrication methods made available by the advent and development of the integrated circuit (IC), admittedly with a less steep commercial growth curve. However the possibility of more precise reaction and analysis control from performing manipulations in channels of 10 to 200 microns across has caused many researchers to embrace the technology in the last 10 years.

The characteristic dimensions and velocities in microfluidic separations are compared to conventional liquid chromatography in the table below. Due to the very small channel sizes, the flow velocity gets smaller while the separations go faster. The effect on the peak width is a reduction in linear dimension of four orders of magnitude. This requires a detector of significantly smaller size than previously used.

The following table provides a comparison of the various physical attributes of conventional liquid chromatography and microfluidic separations.

| | Conventional | Microfluidic |
|---|---|---|
| Tubing cross section (sq. mm) | 0.01 | 0.0001 |
| Flow Rate (μl/mm) | 100 | 0.01 |
| Flow velocity (mm/min) | 10⁴ | 10 |
| Peak width (minutes) | 0.1 | 0.01 |
| Peak width (mm) | 10³ | 0.1 |

What is presently missing in the art is a beta detector that can be incorporated onto a microfluidic device.

### BRIEF SUMMARY OF THE INVENTION

A beta detector assembly for use in the synthesis and analysis of radiopharmaceuticals, such as in microfluidic radiochromatography, is disclosed. The beta detector assembly includes a base, preferably fabricated from glass so as to take advantage of electroosmotic flow, that serves as the body of the beta detector assembly. A microfluidic channel passes through the length of the base. A solid-state charge particle detector, for detecting beta particles, is provided and is positioned with respect to the base so as to receive beta particles. Additionally, in order to allow transmission of beta particles from the microfluidic channel to the solid-state charge particle detector, a collimation well is provided, in one embodiment in the base. A portion of the base is disposed between the microfluidic channel and the solid-state charge particle detector.

In an alternate embodiment, the base and the solid state charge particle detector are integral. In this regard, the base is fabricated of silicon. A microfluidic channel is provided either on the surface or within the body of the silicon base. First and second electrodes are disposed on the silicon either by screen or lithographic techniques.

The present invention may be summarized in a variety of ways, one of which is the following: a detector assembly for quantifying concentration of positron emitters in fluids within a microfluidic assembly, comprising a base; a window formed in the base; a microfluidic channel disposed in the base for allowing liquids to flow through the base; a solid-state charged particle detector supported by the base wherein the window is interpositioned between the charged particle detector and the microfluidic channel; and the window has a thickness sufficient to allow transmission of beta particles from positron emitters within the microfluidic channel to be detected by the solid-state charge particle detector.

The invention may also be summarized as follows: a detector assembly for quantifying a concentration of positron emitters in a microfluidic assembly, the beta detector assembly comprising a base; a microfluidic channel disposed in the base enabling fluids to flow through the base; collimation means disposed in the base proximate the microfluidic channel for collimating charged particles; and a solid-state charged particle detector supported by the base and in communication with the collimation means.

The invention may again be summarized as follows: a detector assembly for quantifying a concentration of positron emitters in a microfluidic assembly, the beta detector assembly comprising a base; a microfluidic channel disposed in the base enabling fluids to flow through the base; a solid-state charged particle detector supported by the base; and window means disposed in the base adjacent the microfluidic channel for increasing the linear resolution of the solid-state charge particle detector.

A portion of the base adjacent the window or window means, and supporting the solid state charge particle detector preferably has a thickness sufficient to substantially attenuate the transmission of beta particles whereby a linear resolution of the solid-state charge particle detector is increased.

The detector assembly preferably further comprises a collimation well, or collimation means, of a selected depth is disposed in the base and be of a depth sufficient to collimate the beta particles emitted from the liquid within the microchannel enabling the detector to delineate between the particles passing through the window or window means and those attenuated by the base.

In one embodiment, the solid state charged particle detector are integral with one another. The base of the detector assembly may be made from a material selected from the group of materials consisting of glass, polymer, silicon, or derivatives thereof.

A first electrode of the solid-state charge particle detector is preferably disposed on a first side of the base and a second electrode of the solid-state charge particle detector is disposed on a second side of the base in spaced relation from the first side of the base. The microfluidic channel is preferably disposed adjacent the first or the second and the second electrodes.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is perspective view of an embodiment of a beta detector assembly for quantifying concentration of positron emitters in flowing or stationary liquids in a microfluidic assembly..

FIG. 2 is a schematic end view in section of the beta detector assembly illustrated in FIG. 1.

FIG. 3 is a schematic side view in section of the beta detector assembly illustrated in FIG. 1.

FIG. 4 is a schematic end view of an alternate embodiment of the beta detector assembly illustrated in FIG. 1 incorporating two solid-state charge particle detectors.

FIG. 5 is a perspective view of yet another embodiment of a beta detector assembly in which the base of the beta detector assembly and the solid-state charge particle detector are integral.

FIG. 6 is a schematic end view of the embodiment illustrated in FIG. 5.

FIG. 7 is a schematic end view of an alternate embodiment of the beta detector assembly of the present invention in which the microfluidic channel is fabricated into a silicon bar enabling the base of the beta detector assembly and the solid-state charge particle detector to be integral.

FIG. 8 is a schematic end view of still another embodiment of a solid-state beta detector assembly in which the base of the beta detector assembly and the solid-state charge particle detector are integral.

### DETAILED DESCRIPTION OF THE INVENTION

A beta detector assembly for use in the synthesis and analysis of radiopharmaceuticals, such as in microfluidic radiochromatography, is disclosed and illustrated generally by the reference numeral 10 in the figures. The beta detector assembly 10 includes a base 15, preferably fabricated from glass that serves as the body of the beta detector assembly 10. A microfluidic channel 20 passes through the length of the base 15. A solid-state charge particle detector 25, for detecting beta particles, is provided and is positioned with respect to the base 15 so as to receive beta particles. In one embodiment the base 15 a collimation well 30 is provided to allow transmission of beta particles from the microfluidic channel 20 to the solid-state charge particle detector 25. A window portion 35 of the base is disposed between the microfluidic channel 20 and the solid-state charge particle detector 25.

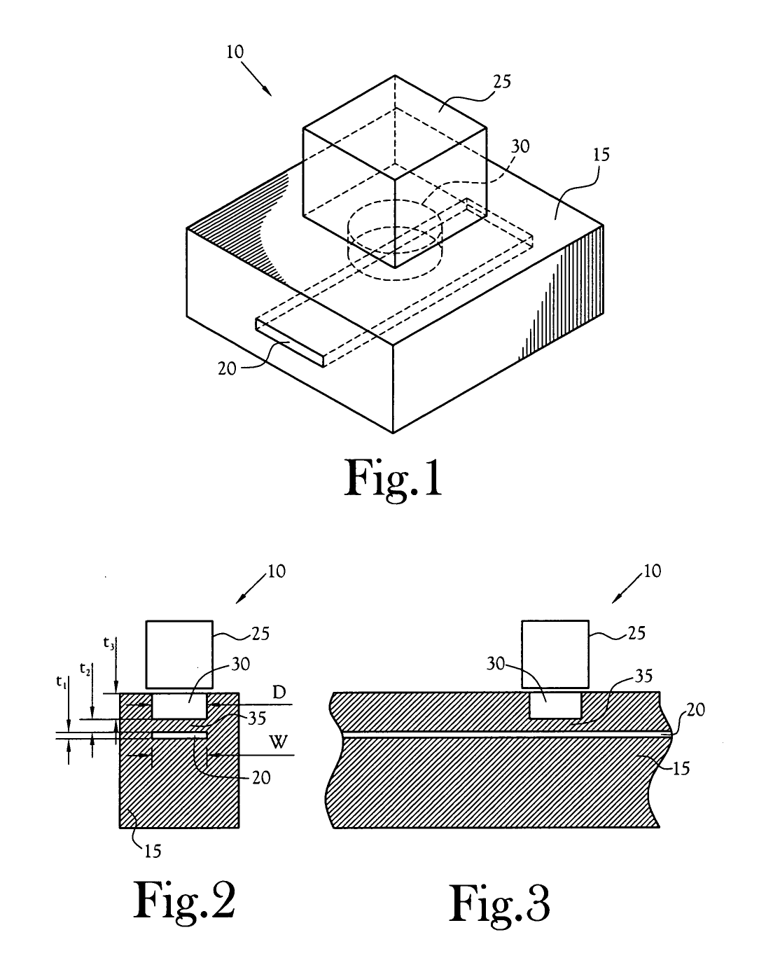

A general schematic of the expected geometry of the first embodiment is illustrated in FIGS. 1-3. The microfluidic channel 20 can be of a variety of dimensions and configurations As described herein, the dimensions of width and height/depth are relative to the placement of the solid-state charge particle detector 25, i.e. these dimension labels assume a top placement of the charge particle detector 25 as illustrated. It should be recognized of course that the illustration and description are not intended to limit the physical orientation or geometry of the beta detector assembly 10 during use. For example, the microfluidic channel 20 could be as narrow as approximately 2 μm and as wide as, for example, 1000 μm, depending upon the desired flow rate characteristics through the microfluidic channel 20. Similarly, while the minimum height of the microfluidic channel 20 is selected based upon microfabrication limits and the necessity of maintaining flow-rate, the upper limit of the height of the microfluidic channel 20 is preferably selected in order to prevent the fluid within the microfluidic channel 20 from self-absorbing, or attenuating the beta particles. In this regard the height of the microfluidic channel 20 should be in the range of approximately 1 μm to approximately 200 μm for F-18 decay. Other fluid systems or isotopes might dictate other dimensions.

While the beta detector assembly 10 could be fabricated of glass, polymers, silicons, and derivatives thereof, or other materials utilized in the microfluidic chemistry art, it will be appreciated that fabricating the beta detector assembly from glass constitutes a preferred embodiment. In order to allow passage of beta particles from the fluid within the microfluidic channel 10 to the solid-state charge particle detector 25, the collimation well 30 is provided in the surface of the substrate. In the figures, the collimation well 30 is illustrated as a cylindrical feature, but it will be recognized that the collimation well 30 could have virtually any geometric or complex configuration.

With reference to FIG. 2, the collimation well 30 has a depth designated generally by the alphanumeric reference t₃. The depth of the collimation well 30 should be selected such that the surrounding substrate, i.e. the surrounding base material is thick enough to substantially attenuate beta particles with energies that are characteristic of the decay of the selected isotope (e.g. 635 keV for F-18). The window portion 35 of the base 15 that is disposed between the microfluidic channel 20 and the solid-state charge particle detector 25 window is preferably in the in range of approximately 50 μm to approximately 100 μm and is designated generally by the alphanumeric reference t₂, and selected to allow transmission of beta particles there through. The solid-state charge particle detector 25 is preferably larger than or similar in size to the diameter of the collimation well 30 but it is conceivable that is may be sized proportionately depending upon the desired result.

The system described here has been found capable of linear resolutions below one millimeter. In addition, the presently described system requires a minimum activity of approximately 28.6 nCi. In calculations, a preferred embodiment of the present inventive system has shown a linear resolution of approximately 0.3 mm, a sensitive volume of approximately 0.18 nl and has the additional advantage of being located “on-chip”.

The maximum activity will be determined by the pulse width of the detector. Typical rise times for inexpensive silicon solid-state charged particle detectors are on the order of a few nanoseconds. By using thin depletion regions, which help reduce gamma background, the rise time is minimized. Fast electronics enable count rates of 1e7 counts per second without significant dead time effects, representing 6 orders of magnitude increase over the minimum detectable activity or about 29 mCi in the 0.18 nl sensitive volume.

In addition to a large range, small sensitive volumes, and on-chip detection, the present invention performs inexpensive assays of radioactivity without the use of scintillators, photomultiplier tubes, or coincidence electronics, etc.

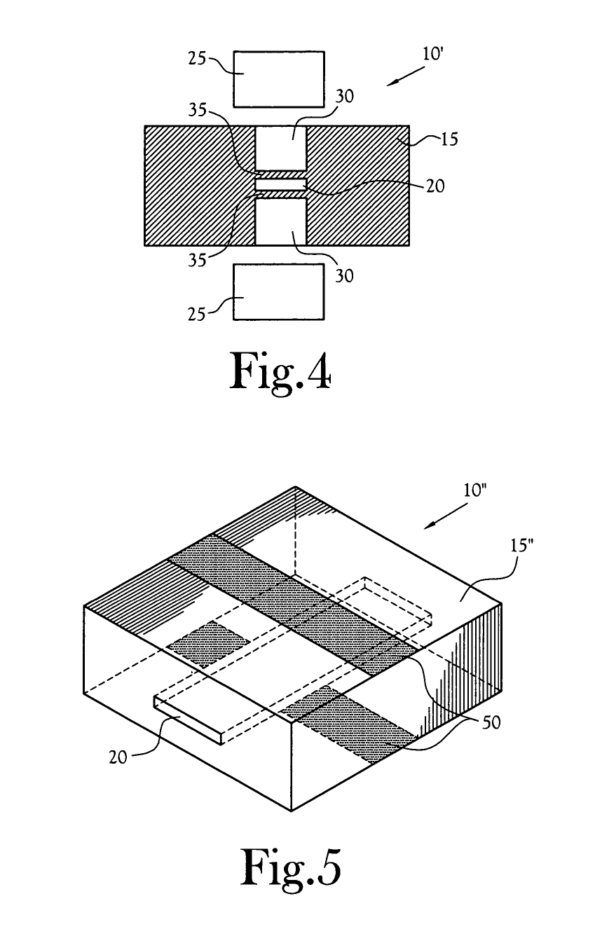

Alternate embodiments of the present invention are disclosed in the remaining figures. For example, the geometry described above only takes advantage of something less than n solid angle geometry. However, the detector assembly 10′, as illustrated in FIG. 4, could be provided with multiple solid-state charged particle detectors positioned on opposing or various sides of the microfluidic channel 20 depending upon its geometry, thereby increasing the counting efficiency while maintaining linear resolution.

As illustrated in FIGS. 5-7 the window material and the dead layer of the silicon solid-state charge particle detector 10′″ could be formed or constructed as a single component or an assembled modular device constituting the same element. In this instance, the microfluidic plate is preferably fabricated entirely out of silicon, and a combination dead layer/channel surface 20′ is preferably fabricated by vapor deposition or other similar technique. Although the conversion of the liquid surface to conductor renders it to be of minimal utility for electro-osmotic flow (EOF), hydrodynamic flow is useful and EOF pumps could be used upstream or downstream of the flow.

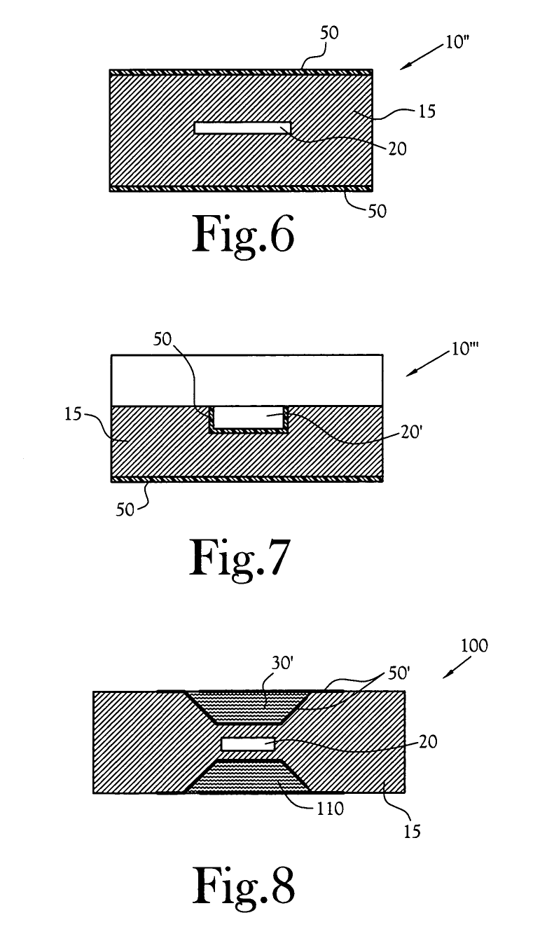

Referring to FIGS. 6 and 7, an alternate embodiment of a detector assembly 10″ is illustrated. In this embodiment, the detector is preferably constructed of any suitable semiconducting material and while silicon is preferred the invention is not so limited. Accordingly, base 15′ is constructed of silicon and a microfluidic channel 20 is fabricated in the silicon. An optional dead layer on the fluidic surface of the microfluidic channel 20 may be provided depending upon the configuration and desired or intended usage. The electrodes 50 could be deposited on the outside of the device, but it is also conceivable to position them internally within the confines of the base 15′ to minimize inadvertent and potentially deleterious contact with other components or foreign articles.

Accordingly, it will be appreciated as within the scope of the present invention that the fabrication of the entire assembly can be completely automated; and the geometry can be reproduced with significant accuracy using lithographic techniques. In such a manner, the silicon detector is completely integrated into the chip and uses lithographed glass surfaces for collimation of the positrons.

With respect to FIG. 8, the beta detector assembly 100 is directly supported by the microfluidic chip and does not require substantially perpendicular or straight sides for the collimation well 30′. In this embodiment, the beta detector assembly 100 is preferably fabricated entirely out of silicon or any other suitable material as mentioned above, and the collimation wells 30′ are fabricated by means of potassium hydroxide (KOH) etching of the preferred silicon. It will be recognized that this etching technique in silicon renders a sloped or arcuate collimation well 30′.

The collimation well(s) 30′ can then be plated with a suitable conducting material to serve as electrodes 50′ with additional silicon 110 deposited therein, to form a detector assembly 100 with naturally higher solid angle.

Although the preferred use of the detector disclosed and described herein is for chromatography applications, the detector may also be used in radiotracer applications and comprise a portion of a radiotracer dispensing system.

From the foregoing description, it will be recognized by those skilled in the art that the present invention comprises a beta detector assembly for use in conjunction with the synthesis and analysis of radiopharmaceuticals (e.g., “microfluidic radiochromatography”), and offers significant advantages over prior devices and methods.

While the present invention has been illustrated by description of several embodiments and while the illustrative embodiments have been described in considerable detail, it is not the intention of the applicant to restrict or in any way limit the scope of the appended claims to such detail. Additional advantages and modifications will become apparent after consideration of the description and claims forming the disclosure, as well as the claims appended hereto. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, we claim:

1. A detector assembly for quantifying concentration of positron emitters in fluids within a microfluidic assembly, comprising:
a base;
a window formed in the base;
a microfluidic channel disposed in the base for allowing liquids to flow through the base;
a solid-state charged particle detector supported by the base wherein the window is interpositioned between the charged particle detector and the microfluidic channel; and
the window has a thickness sufficient to allow transmission of beta particles from positron emitters within the microfluidic channel to be detected by the solid-state charge particle detector.

2. The detector assembly of claim 1 wherein:
a portion of the base adjacent the window and supporting the solid state charge particle detector has a thickness sufficient to substantially attenuate the transmission of beta particles whereby a linear resolution of the solid-state charge particle detector is increased.

3. The detector assembly of claim 1 further comprising:
a collimation well of a selected depth is disposed in the base.

4. The detector assembly of claim 3, wherein:
the collimation well is disposed between the window and the solid-state charge particle detector.

5. The detector assembly of claim 4, wherein the collimation well further comprises:
a continuous side wall defined by the base.

6. The detector assembly of claim 5, wherein the collimation well further includes:
a depth sufficient to collimate the beta particles emitted from the liquid within the microchannel enabling the detector to delineate between the particles passing through the window and those attenuated by the base.

7. The detector assembly of claim 1 wherein:
the base and the solid-state charged particle detector are integral with one another.

8. The detector assembly of claim 1 wherein:
a first electrode of the solid-state charge particle detector is disposed on a first side of the base and a second electrode of the solid-state charge particle detector is disposed on a second side of the base in spaced relation from the first side of the base.

9. The detector assembly of claim 8 wherein:
the microfluidic channel is disposed adjacent the first or the second and the second electrodes.

10. The detector assembly of claim 1 wherein:
the base is at least in part made from a material selected from the group of materials consisting of glass, polymer, silicon, or derivatives thereof.

11. The detector assembly of claim 6 wherein:
the base is at least in part made from a material selected from the group of materials consisting of glass, polymer, silicon, or derivatives thereof.

12. The detector assembly of claim 7 wherein:
the base is at least in part made from a material selected from the group of materials consisting of glass, polymer, acrylic, silicon, or derivatives thereof.

13. The detector assembly of claim 9 wherein:
the base is at least in part made from a material selected from the group of materials consisting of glass, polymer, acrylic, silicon, or derivatives thereof.

14. A detector assembly for quantifying a concentration of positron emitters in a microfluidic assembly, the beta detector assembly comprising:
a base;
a microfluidic channel disposed in the base enabling fluids to flow through the base;
collimation means disposed in the base proximate the microfluidic channel for collimating charged particles; and
a solid-state charged particle detector supported by the base and in communication with the collimation means.

15. The detector assembly of claim 14 wherein:
a portion of the base adjacent the window and supporting the solid state charge particle detector has a thickness sufficient to substantially attenuate the transmission of beta particles whereby a linear resolution of the solid-state charge particle detector is increased.

16. The detector assembly of claim 14, wherein:
the collimation means is disposed between the window and the solid-state charge particle detector.

17. The detector assembly of claim 16, wherein the collimation means further comprises:
a continuous side wall defined by the base.

18. The detector assembly of claim 17, wherein:
the collimation means has a depth sufficient to collimate the charged particles emitted from the liquid within the microchannel enabling the detector to delineate between the particles passing through the window and those attenuated by the base.

19. The detector assembly of claim 14 wherein:
the base and the solid-state charged particle detector are integral with one another.

20. The detector assembly of claim 14 wherein:
a first electrode of the solid-state charge particle detector is disposed on a first side of the base and a second electrode of the solid-state charge particle detector is disposed on a second side of the base in spaced relation from the first side of the base.

21. The detector assembly of claim 20 wherein:
the microfluidic channel is disposed adjacent the first or the second and the second electrodes.

22. The detector assembly of claim 14 wherein:
the base is at least in part made from a material selected from the group of materials consisting of glass, polymer, silicon, or derivatives thereof.

23. The detector assembly of claim 18 wherein:
the base is at least in part made from a material selected from the group of materials consisting of glass, polymer, silicon, or derivatives thereof.

24. The detector assembly of claim 19 wherein:
the base is at least in part made from a material selected from the group of materials consisting of glass, polymer, silicon, or derivatives thereof.

25. A detector assembly for quantifying a concentration of positron emitters in a microfluidic assembly, the beta detector assembly comprising:
a base;
a microfluidic channel disposed in the base enabling fluids to flow through the base;
a solid-state charged particle detector supported by the base; and
window means disposed in the base adjacent the microfluidic channel for increasing the linear resolution of the solid-state charge particle detector.

26. The detector assembly of claim 25 wherein:
a portion of the base adjacent the window means and supporting the solid state charge particle detector has a thickness sufficient to substantially attenuate the transmission of beta particles whereby a linear resolution of the solid-state charge particle detector is increased.

27. The detector assembly of claim 25 further comprising:
a collimation well of a selected depth is disposed in the base.

28. The detector assembly of claim 27, wherein:
the collimation well is disposed between the window means and the solid-state charge particle detector.

29. The detector assembly of claim 27, wherein:
the collimation well further comprises: a continuous side wall defined by the base.

30. The detector assembly of claim 29, wherein the collimation well further includes:
a depth sufficient to collimate the beta particles emitted from the liquid within the microchannel enabling the detector to delineate between the particles passing through the window and those attenuated by the base.

31. The detector assembly of claim 25 wherein:
the base and the solid-state charged particle detector are integral with one another.

32. The detector assembly of claim 25 wherein:
a first electrode of the solid-state charge particle detector is disposed on a first side of the base and a second electrode of the solid-state charge particle detector is disposed on a second side of the base in spaced relation from the first side of the base.

33. The detector assembly of claim 32 wherein:
the microfluidic channel is disposed adjacent the first or the second and the second electrodes.

34. The detector assembly of claim 25 wherein:
the base is at least in part made from a material selected from the group of materials consisting of glass, polymer, silicon, or derivatives thereof.

35. The detector assembly of claim 28 wherein:
the base is at least in part made from a material selected from the group of materials consisting of glass, polymer, silicon, or derivatives thereof.

36. The detector assembly of claim 31 wherein:
the base is at least in part made from a material selected from the group of materials consisting of glass, polymer, silicon, or derivatives thereof.

37. The detector assembly of claim 32 wherein:
the base is at least in part made from a material selected from the group of materials consisting of glass, polymer, silicon, or derivatives thereof.
